(19) United States
(12) Patent Application Publication
(10) Pub. No.: US 2024/0111022 A1
(43) Pub. Date: Apr. 4, 2024

(54) METHOD FOR SELF-MONITORING, AND RADAR SENSOR

(71) Applicant: Robert Bosch GmbH, Stuttgart (DE)

(72) Inventors: Andrej Sagainov, Leonberg (DE); Michael Ott, Leonberg (DE)

(21) Appl. No.: 18/455,369

(22) Filed: Aug. 24, 2023

(30) Foreign Application Priority Data
Oct. 4, 2022 (DE) 10 2022 210 475.7

(51) Int. Cl. G01S 7/40; H04W 64/00

(52) U.S. Cl. CPC G01S 7/4069; H04W 64/003

(57) ABSTRACT

A method for self-monitoring of a radar sensor, which carries out object detection of an object by way of a measurement process on the basis of a measurement signal and is monitored by way of self-monitoring carried out during the measurement process using a test signal superimposed on the measurement signal. The test signal is encoded by signal encoding such that it can be differentiated from the measurement signal. A radar sensor is also described.

### CROSS REFERENCE

The present application claims the benefit under 35 U.S.C. § 119 of German Patent Application No. DE 10 2022 210 475.7 filed on Oct. 4, 2022, which is expressly incorporated herein by reference in its entirety.

### FIELD

The present invention relates to a method for self-monitoring. The present invention further relates to a radar sensor.

### BACKGROUND INFORMATION

German Patent Application No. DE 10 2010 002 759 A1 describes a radar sensor comprising a local oscillator for generating a transmit signal, a transceiver having direct coupling between a transmit path and a receive path, a mixer for generating an intermediate frequency signal by mixing part of the transmit signal with a signal received in the receive path, an evaluation device for evaluating the intermediate frequency signal, and a self-test device. The self-test device is configured to supply to the mixer, instead of the part of the transmit signal, a test signal which has a test frequency that is frequency-shifted relative to the transmit signal by a fixed amount. The self-test evaluates the intermediate frequency signal in relation to the test frequency. The test signal is not present in a normal measurement operation.

German Patent Application No. DE 10 2020 117 748 A1 describes a radar system in which an RF test signal is modulated to an RF signal and is superimposed on a received antenna signal in order to translate this to baseband by way of a mixer. The test signal has a test frequency that is outside a useful frequency range for the object detection.

Self-monitoring is expedient for increasing the functional safety of the radar sensor.

### SUMMARY

According to the present invention, a method for self-monitoring is provided. According to an example embodiment of the present invention, a method is provided for self-monitoring of a radar sensor, which carries out object detection of an object by way of a measurement process on the basis of a measurement signal and is monitored by way of self-monitoring carried out during the measurement process using a test signal superimposed on the measurement signal. The test signal is encoded by signal encoding such that it can be differentiated from the measurement signal.

This method can distinguish the test signal from the measurement signal more precisely. The test signal can be resolved more reliably and the object detection can be carried out by the self-monitoring while being affected to a lesser extent. The energy consumption of the radar sensor can be reduced.

The radar sensor can be arranged in a stationary manner, in particular on a transport infrastructure system or on a vehicle, preferably a road vehicle, a rail-borne vehicle, an aircraft, or a watercraft. The radar sensor can be used for semi-autonomous or autonomous operation of the vehicle. The object detection of the object by way of the measurement process can be assigned to an environment monitoring unit of the vehicle. The object detection can be assigned to a driver assistance system and/or a semi-autonomous or autonomous driving system of the vehicle.

The object can be a living organism, in particular a person, or an item, a building, or another means of transport. The object can be a transport infrastructure or part of a transport infrastructure, for example a road sign.

“Self-monitoring” is preferably understood to be monitoring of a function, reliability, accuracy, or a comparable property of the radar sensor itself. The self-monitoring can be used for increasing the functional safety of the radar sensor.

The radar sensor can detect an object distance as a distance between the radar sensor and the object, an object velocity as the relative velocity of the object relative to the radar sensor, and an azimuth angle and/or an elevation angle in the detection field of the radar sensor.

The measurement signal can be a radio-frequency signal. The measurement signal can be a baseband signal, resulting from the superimposition of at least two radio-frequency signals.

The radar sensor can comprise at least one antenna for emitting a transmit signal for forming the measurement signal. The radar sensor can comprise at least one antenna for receiving the transmit signal reflected by an object for forming the measurement signal. The emitting antenna and the receiving antenna can be different from one another or can be formed by the same component.

The transmit signal to be emitted can be fed to the antenna over a transmit path. The receive signal can be transmitted from the antenna over a receive path.

The test signal can be superimposed on the transmit signal to be emitted. The test signal can be separate from the transmit signal to be emitted. The test signal can be superimposed on the receive signal. The test signal can be separate from the receive signal.

The method for self-monitoring can perform monitoring of the transmit path and/or the receive path. The test signal can be based on a radio-frequency signal or a baseband signal.

The signal encoding can include amplitude modulation and/or frequency modulation of the test signal. As an alternative or in addition to the position in a receive band (positive frequencies), the test signal can be in an image frequency band (negative frequencies) when I/Q demodulation is used.

The test signal can be generated by direct digital synthesis (DDS) and/or by analog oscillators. The test signal can be formed by a signal generator, in particular a square-wave generator, a triangular wave generator, and/or a sawtooth generator. The test signal can be formed by phase shift keying and/or amplitude shift keying. The phase shift keying and/or amplitude shift keying can be performed using an I/Q mixer or without an I/Q mixer, using an inverting or non-inverting amplifier, and/or using a switchable cable length.

In a preferred example embodiment of the present invention, it is advantageous for the signal encoding to include code-division multiple access. As a result, the test signal can be identified and resolved in an improved manner.

In a special example embodiment of the present invention, it is advantageous for the code-division multiple access to multiply the test signal by a spread code pattern. The spread code pattern can comprise orthogonal spread codes. When using orthogonal spread codes for the length n, a test signal amplitude of the test signal can be reduced by 10×log₁₀(n). As a result, the energy consumption during the self-monitoring can be reduced.

In a special example embodiment of the present invention, it is advantageous for the signal encoding to be performed by frequency-division multiplexing. In this case, the carrier signals can be divided between the measurement signal and the test signal.

In a special embodiment of the present invention, it is advantageous for the frequency-division multiplexing to be orthogonal frequency-division multiplexing. In this case, the test signal can be implemented by a sub-carrier.

In an advantageous example embodiment of the present invention, it is provided that the signal encoding includes time-division multiplexing. As a result, the self-monitoring can be implemented in a simpler manner.

In a preferred example embodiment of the present invention, it is provided that the test signal is superimposed on the measurement signal in first time intervals that alternate with superimposition-free second time intervals. As a result, targets that arise in the measurement signal only in the first time intervals having the superimposed test signal can be detected as intermodulation amplitudes and can be distinguished from the detection of object targets. Furthermore, the intermodulation amplitudes can be lower. When there is a sufficient number of first time intervals, protection against interference phenomena can be provided.

In an advantageous example embodiment of the present invention, it is provided that the signal encoding includes Doppler-division multiplexing.

A preferred example embodiment of the present invention in which the test signal is offset from the measurement signal by a Doppler shift in the Doppler dimension is advantageous. The Doppler shift is preferably greater than the Doppler shift arising in the detection of targets.

According to the present invention, a radar sensor having self-monitoring is also provided.

Further advantages and advantageous embodiments of the present invention become apparent from the description of the figures and from the figures.

### BRIEF DESCRIPTION OF THE DRAWINGS

The present invention will be described in detail below with reference to the figures.

FIG. 1 shows a method for self-monitoring in a special specific embodiment of the present invention.

FIG. 2 shows the generation of a test signal in a method for self-monitoring in a further special specific embodiment of the present invention.

FIG. 3 is a frequency-dependent amplitude graph of a radar sensor in a special specific embodiment of the present invention.

FIG. 4 is a frequency-dependent amplitude graph of a radar sensor in a further special specific embodiment of the present invention.

### DETAILED DESCRIPTION OF EXAMPLE EMBODIMENTS

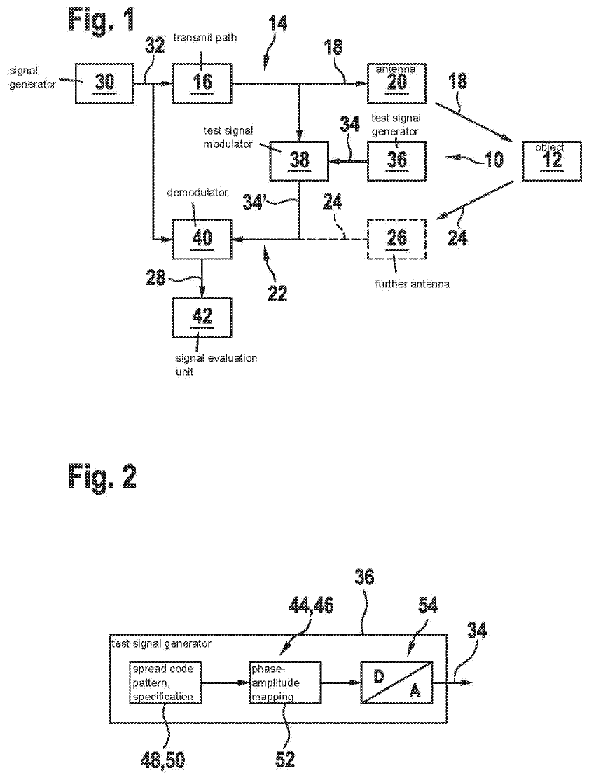

FIG. 1 shows a method for self-monitoring in a special specific embodiment of the present invention. The method for self-monitoring 10 of a radar sensor is in particular carried out for monitoring a function, reliability, and accuracy of the radar sensor. The radar sensor makes it possible to detect an object 12 by way of a measurement process 14 and comprises a transmit path 16 for emitting a transmit signal 18 via an antenna 20 and at least one receive path 22 for receiving the emitted transmit signal 18 reflected by the object 12 as the receive signal 24 via the antenna or a further antenna 26.

The transmit signal 18 and the receive signal 24 form a measurement signal 28 for the object detection. The transmit signal 18 is generated by a signal generator 30, which outputs a radio-frequency signal 32 having a frequency of 77 GHz, for example.

During the self-monitoring, a test signal 34 is generated by a test signal generator 36 and is relayed to a test signal modulator 38 together with the transmit signal 18 branched off downstream of the transmit path 16. Said test signal modulator modulates the test signal 34 to the transmit signal 18 branched off immediately upstream of the antenna 20. The modulated test signal 34′ is superimposed on the receive signal 24, separated from the carrier signal by a demodulator 40, and relayed to a signal evaluation unit 42, which evaluates the modulated test signal 34′.

The self-monitoring proceeds at the same time as the measurement process 14. A frequency of the measurement signal 28 for the object detection is in a useful frequency range. The test signal 34 has a predetermined test frequency, which is in the useful frequency range. As a result, any existing, frequency-dependent interference of the radar sensor relating to the useful frequency range can be identified in an improved manner.

The self-monitoring facilitates monitoring of the transmit path 16 and the receive path 22 and of the frequency conversion by the demodulator 40.

FIG. 2 shows the generation of a test signal in a method for self-monitoring in a further special specific embodiment of the present invention. The test signal 34 is encoded by signal encoding 44 such that it can be differentiated from the measurement signal. As a result, the test signal 34 superimposed on the measurement signal can be resolved in an improved manner.

The test signal 34 is generated by the test signal generator 36, which encodes the test signal 34 by signal encoding 44. The signal encoding 44 can include code-division multiple access 46, in which the test signal 34 is multiplied by a spread code pattern 48. The test signal 34 is generated by direct digital synthesis (DDS). A specification 50, for example the spread code pattern 48, is relayed to a digital-to-analog converter 54 (D/A converter) via phase-amplitude mapping 52, in particular by a lookup table, which digital-to-analog converter generates the test signal 34 therefrom.

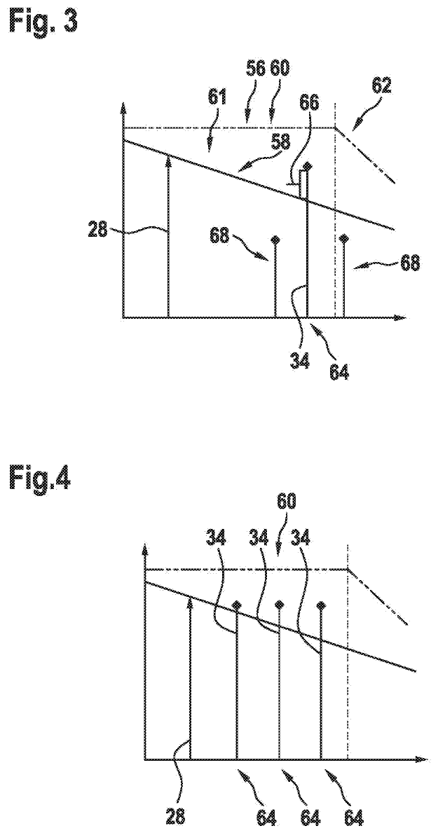

FIG. 3 is a frequency-dependent amplitude graph of a radar sensor in a special specific embodiment of the present invention. The double-logarithmic representation in the amplitude graph illustrates both a transfer function 56 of a frequency filter processing the measurement signal 28 and a frequency-dependent amplitude curve 58 of a maximum amplitude of the measurement signal 28 in the object detection. The maximum amplitude of the measurement signal 28 decreases as the frequency increases.

The frequency filter is configured as a low-pass filter and the pass frequency range 60 is below the blocking frequency range 62. The test frequency 64 of the test signal 34 is within the pass frequency range 60 and the useful frequency range 61 of the measurement signal 28. As a result, any existing, frequency-dependent interference of the radar sensor relating to the useful frequency range 61 can be identified in an improved manner. At the test frequency 64, an amplitude of the test signal 34 is greater than the greatest expected amplitude of the measurement signal 28 by an amplitude distance 66.

The test signal 34 present during the object detection brings about intermodulation amplitudes 68 on either side of the test frequency 64 where applicable. These intermodulation amplitudes 68 usually have a lower amplitude than the measurement signal 28 at the same frequency.

FIG. 4 is a frequency-dependent amplitude graph of a radar sensor in a further special specific embodiment of the present invention. The test signal 34 is composed of a plurality of simultaneous individual test signals 34 each having different test frequencies 64. The different test frequencies 64 can likewise be in the pass frequency range 60 of the frequency filter, together with the measurement signal 28. To show this more clearly, possible intermodulation amplitudes have been omitted.

What is claimed is:

1. A method for self-monitoring of a radar sensor, which carries out object detection of an object using a measurement process based on a measurement signal, the method comprising:
self-monitoring, by the radar sensor, during the measurement process using a test signal superimposed on the measurement signal;
wherein the test signal is encoded by signal encoding such that the encoded test signal can be differentiated from the measurement signal.

2. The method for self-monitoring as recited in claim 1, wherein the signal encoding includes code-division multiple access.

3. The method for self-monitoring as recited in claim 2, wherein the code-division multiple access multiplies the test signal by a spread code pattern.

4. The method for self-monitoring as recited in claim 1, wherein the signal encoding takes place by frequency-division multiplexing.

5. The method for self-monitoring as recited in claim 4, wherein the frequency-division multiplexing is orthogonal frequency-division multiplexing.

6. The method for self-monitoring as recited in claim 1, wherein the signal encoding includes time-division multiplexing.

7. The method for self-monitoring as recited in claim 6, wherein the test signal is superimposed on the measurement signal in first time intervals that alternate with superimposition-free second time intervals.

8. The method for self-monitoring as recited in claim 1, wherein the signal encoding includes Doppler-division multiplexing.

9. The method for self-monitoring as recited in claim 8, wherein the test signal is offset from the measurement signal by a Doppler shift in a Doppler dimension.

10. A radar sensor configured to detect an object using a measurement process based on a measurement signal, the radar sensor comprising:
a self-monitoring unit configured for self-monitoring of the radar sensor, the self-monitoring unit configured to:
self-monitor during the measurement process using a test signal superimposed on the measurement signal,
wherein the test signal is encoded by signal encoding such that the encoded test signal can be differentiated from the measurement signal.
